(19) United States
(12) Patent Application Publication
(10) Pub. No.: US 2018/0276341 A1
(43) Pub. Date: Sep. 27, 2018

(54) SECURE PERSON IDENTIFICATION AND TOKENIZED INFORMATION SHARING

(71) Applicant: Hackensack University Medical Center, Hackensack, NJ (US)

(72) Inventors: Shafiq Rab, Skillman, NJ (US); Jeremy A. Marut, Bloomingdale, NJ (US); Modi Boutrs, Midland Park, NJ (US)

(21) Appl. No.: 15/467,806

(22) Filed: Mar. 23, 2017

(51) Int. Cl. G06F 19/00; G06F 21/62

(52) U.S. Cl. CPC G06F 19/322; G06F 21/6245

(57) ABSTRACT

Systems and methods for accessing patient data include, in response to a request for consent for a medical professional to access patient data of a patient, receiving a request from the patient for a token validating an identity of the patient. The token is transmitted to the patient. The consent is received from the patient with data access attributes using the token. The data access attributes include an expiration time associated with the consent and a granular level of access defining one or more subsets of the patient data the medical professional is authorized to access. A notification is transmitted to a communication address associated with the medical professional. The notification indicates that the medical professional is authorized to access the patient data in accordance with the data access attributes.

### FIELD OF THE INVENTION

The described invention relates to patient data portability, and more particularly to a system for facilitating granular and meaningful access to patient data by the patient.

### BACKGROUND OF THE INVENTION

Electronic health record systems provide for the systemic collection of large amounts of patient data electronically stored in a digital format. Access to this patient data is important for physicians to make clear, well informed decisions about the care of a patient. However, portability of patient data between different health care providers is difficult to implement in a secure and timely manner, as each hospital or physician's office maintains its own electronic health record system storing patient data in different formats. Such fragmentation in electronic health record systems makes patient data portability difficult, if not impossible.

The United States government is continuing to develop regulations to require the electronic sharing of health information. Such regulations have driven emerging data sharing standards based on standard off-the-shelf web programming APIs (application program interfaces). These standards are gaining momentum across the country and allow for the exchange of patient data in a standardized format. However, the biggest challenge for implementing patient data portability is a standard or centralized patient identification system which can unify the limitless identities a given patient can have across the various electronic health record systems to facilitate access to data of the patient over the continuum of the patient's care.

What is needed is a system for implementing patient mediated exchange of data in which the patients manages the exchange his or her patient data, thereby reducing or eliminating liabilities surrounding consent to access the patient data.

### SUMMARY

In accordance with one or more embodiments, systems and methods for facilitating the patient mediated exchange of data. In response to a request for consent for a medical professional to access patient data of a patient, a request is received from the patient for a token validating an identity of the patient. The token is transmitted to the patient. The consent is received from the patient with data access attributes using the token. The data access attributes include an expiration time associated with the consent and a granular level of access defining one or more subsets of the patient data the medical professional is authorized to access. A notification is transmitted to a communication address associated with the medical professional. The notification indicates that the medical professional is authorized to access the patient data in accordance with the data access attributes.

In accordance with one or more embodiments, the token and the data access attributes are transmitted to a token gatekeeper. The token gatekeeper stores an association between the patient and the token and the data access attributes. Each transaction for the medical professional to access the patient data is authorized by the token gatekeeper based on the data access attributes. Each transaction for the medical professional to access the patient data is recorded by the token gatekeeper.

In accordance with one or more embodiments, the token is generated in response to the request from the patient from the token by validating the identity of the patient. In accordance with another embodiment, a previously generated token associated with the patient is retrieved from the token gatekeeper.

In accordance with one or more embodiments, the one or more subsets of patient data are defined based on a structure of the patient data. The structure of the patient data may define the subsets of data as being associated with one or more of patient demographics, allergies, diagnoses, family member history, and operation or therapy history.

In accordance with one or more embodiments, the request for consent for the medical professional to access the patient data is in response to an invitation sent to the medical professional to access the patient data. The invitation may be sent by the patient searching for the communication address associated with the medical professional. If the medical professional is not found during the searching, the medical professional is registered. The communication address associated with the medical professional may be authenticated to be associated with the medical professional.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a high-level diagram of a communications system, in accordance with one embodiment;

FIG. 2 shows a high-level message diagram for facilitating access to patient data, in accordance with one embodiment;

FIG. 3 shows a block diagram of a system architecture for generating a unique digital identifying token for a patient, in accordance with one embodiment;

FIG. 4 shows a flow diagram of a method for a patient search of a medical provider, in accordance with one embodiment;

FIG. 5 shows a flow diagram of a method for registration of a medical professional with the data access system, in accordance with one embodiment;

FIGS. 6A-6D show exemplary user interfaces for managing access to patient data, in accordance with one embodiment; and

FIG. 7 shows a high-level block diagram of a computer, in accordance with one embodiment.

### DETAILED DESCRIPTION

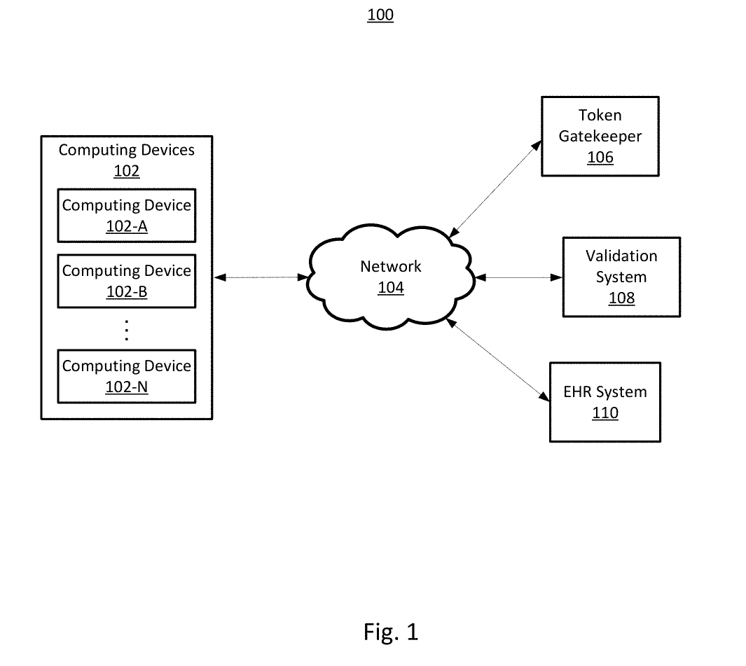

FIG. 1 shows a high-level diagram of a communications system 100, in accordance with one or more embodiments. Communications system 100 includes one or more computing devices 102-A, 102-B, . . . , 102-N (collectively referred to as computing devices 102). Computing devices 102 may comprise any type of computing device, such as, e.g., a computer, a workstation, a server, a database, a tablet, or a mobile device. Computing devices 102 are operated by end users for communicating via network 104. Network 104 may include any type of network or combination of different types of networks, and may be implemented using any suitable network technology in a wired and/or a wireless configuration. For example, network 104 may include one or more of the Internet, an intranet, a personal area network (PAN), a local area network (LAN), a wide area network (WAN), a metropolitan area network (MAN), a virtual private network (VPN), etc.

End users of computing devices 102 may communicate via network 104 for interacting with devices or systems communicatively coupled to network 104, such as, e.g., other computing devices 102, a token gatekeeper 106, a validation system 108, or one or more electronic health record (EHR) systems 110. EHR system 110 may be any system storing patient data. In one embodiment, the patient data stored in EHR system 110 includes any information that was obtained, used, or disclosed in the course of receiving medical care services, such as, e.g., diagnosis or treatment information. Token gatekeeper 106 facilitates a standardized or centralized patient identification system for accessing patient data stored in EHR system 110.

End users of computing devices 102 may include, e.g., users (e.g., a patient) granting access to patient data stored in EHR system 110, users (e.g., the patient, a medical professional, an insurance company, etc.) accessing patient data in EHR system 110, users (e.g., a medical provider such as a hospital, a physician's office, etc.) maintaining patient data in EHR system 110, or any other suitable user. End users of computing devices 102 may interact with token gatekeeper 106, validation system 108, EHR system 110, or any other device or system communicatively coupled to network 104 via an interface of a web browser executing on computing device 102, an application executing on computing device 102, an app executing on computing device 102, or any other suitable interface for interacting with patient analysis system 106. In one example, end users of computing devices 102 may interact with a software as a service (SaaS) application hosted by token gatekeeper 106, validation system 108, EHR system 110, or any other system for facilitating access to patient data stored on EHR system 110.

Advantageously, embodiments of the present invention facilitate access to patient data stored in EHR system 110. Embodiments of the present invention provide for improvements in computer related technology by providing for a standardized or centralized system for identifying a patient (or other user) to facilitate access to data of the patient. Embodiments of the present invention enable a patient to define granular levels of access to data of the patient, define a time of expiration for which access to the data of the patient is granted, and track each request made for data of the patient.

While embodiments of the present invention are described herein for facilitating access to patient data stored in EHR 110, it should be understood that the embodiments described herein may be employed for facilitating access to any type of data stored in any type of database, and is not limited to patient data.

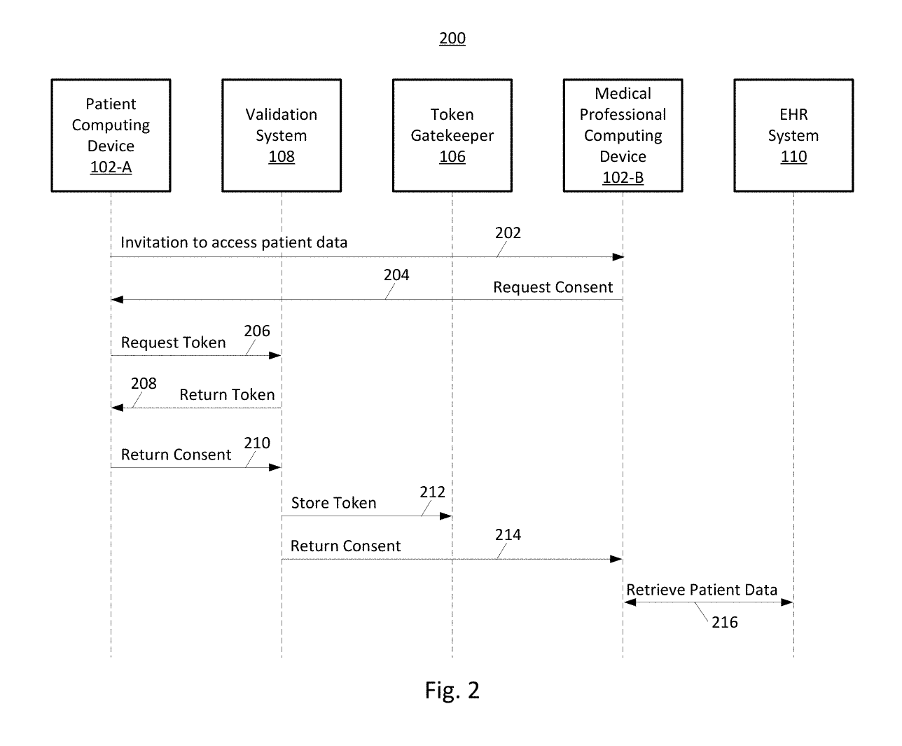

FIG. 2 shows a high-level message diagram 200 for facilitating access to patient data stored in EHR system 110, in accordance with one or more embodiments. FIG. 2 will be discussed with reference to FIG. 1. Boxes at the top of message diagram 200 represent elements of a communication network, such as, e.g., communication network 100. Messages are shown in time starting from top to bottom.

At message 202, an authorizer using computing device 102-A invites an accessor using computing device 102-B to access patient data of the authorizer. In one embodiment, the authorizer is described herein as a patient using patient computing device 102-A to authorize access to his or her own patient data and the accessor is described herein as a medical professional, such as, e.g., a doctor or a hospital, using medical professional computing device 102-B to access the patient data. However, it should be understood that the authorizer may be any entity that can provide authorization to access the patient data and the accessor may be any entity accessing the patient data (e.g., the patient him or herself, an insurance company, etc.). In one embodiment, the patient initiates the invitation to the medical professional for accessing the patient data. In another embodiment, the patient invites the medical professional to access the patient data in response to a request by the medical professional.

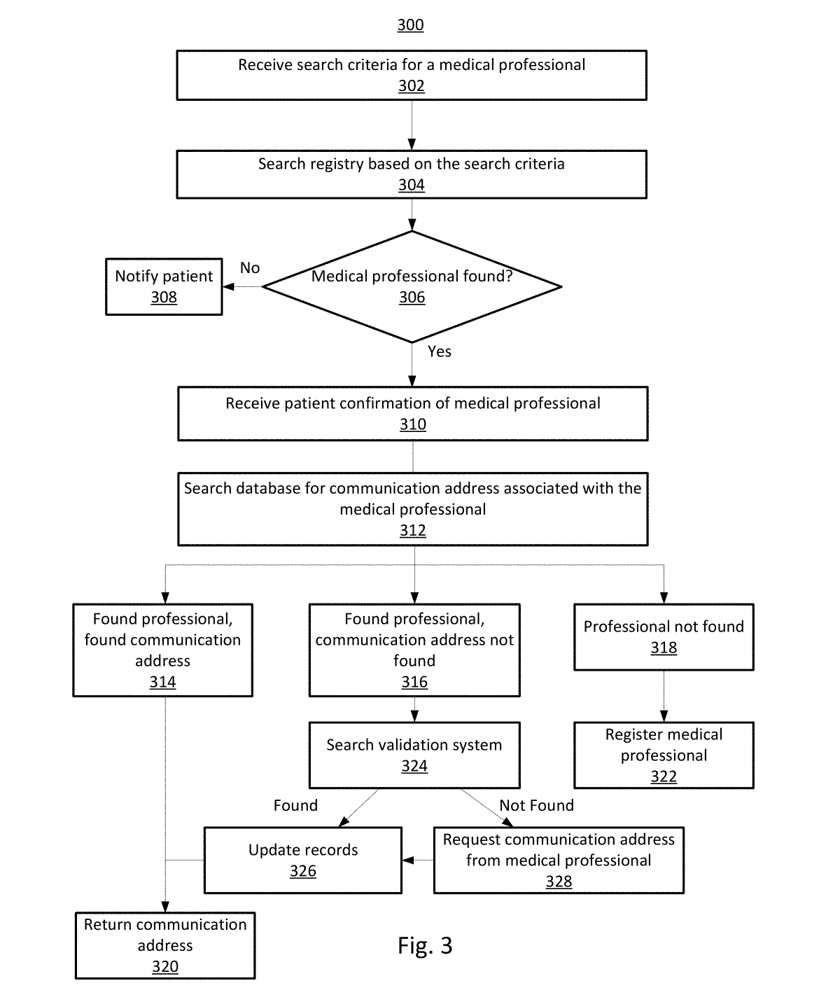

In one embodiment, the patient sends the invitation to access the patient data to the medical professional by manually inputting a communication address (or identifier) associated with the medical professional. In another embodiment, the patient performs a search for the communication address associated with the medical professional. For example, the patient may search any suitable database for the communication address associated with the medical professional. In one embodiment, the patient performs a search for the communication address associated with the medical professional as discussed below with respect to FIG. 3.

The communication address may be any address or account associated with a messaging or communication platform, such as, e.g., an electronic mail (email) address. In one embodiment, the communication address is a secure address or account that is authenticated to be associated with a particular user (e.g., the medical professional). For example, the communication address may be a direct address from DataMotion™. Direct addresses are managed publicly by DirectTrust and DataMotion is a Health Information Service Provider (HISP) which supplies direct addresses for medical professionals and patients. Other secure communication addresses or accounts may also be employed.

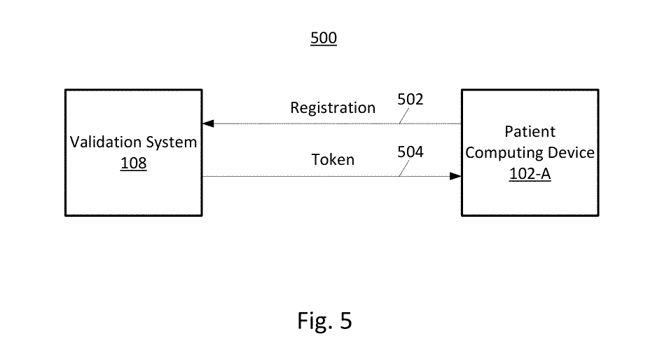

At step 204, in response to the invitation to access patient data, the medical professional at medical professional computing device 102-B requests consent from the patient at patient computing device 102-A. At message 206, the patient requests a token from validation system 108. The token is a unique digital identifying token that validates the identity of the patient. In response, validation system 108 generates the token and, at message 208, validation system 108 returns the token to patient computing device 102-A. The token may be generated using any suitable method. In one embodiment, the token is generated using methods known in the art. In another embodiment, the token is generated as discussed below with respect to FIG. 5.

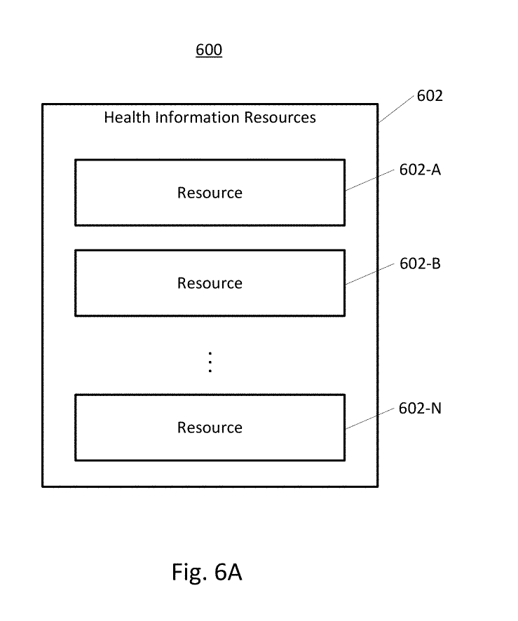

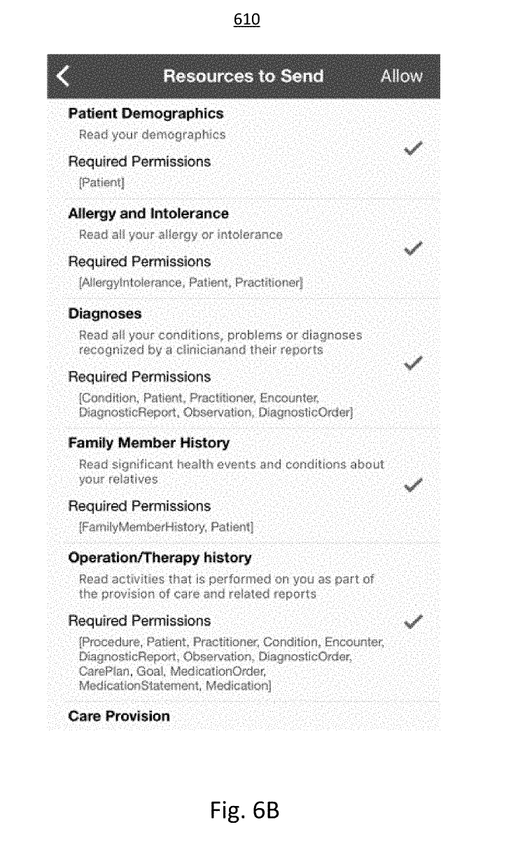

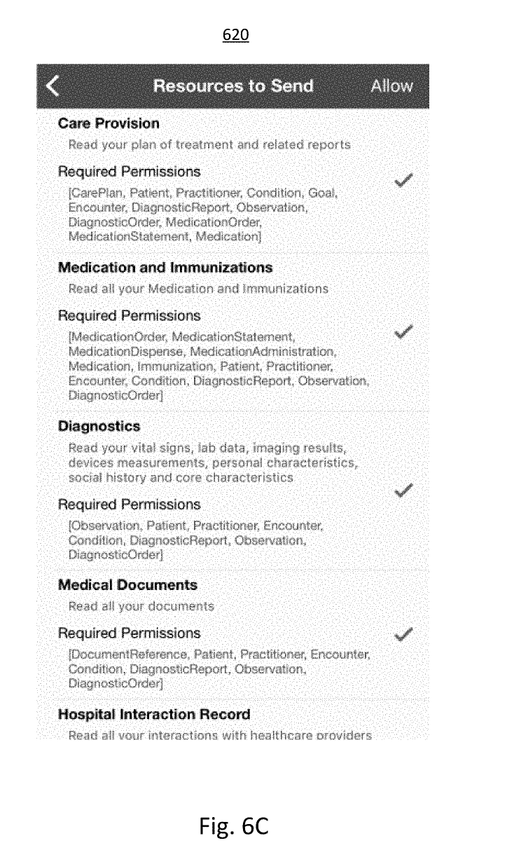

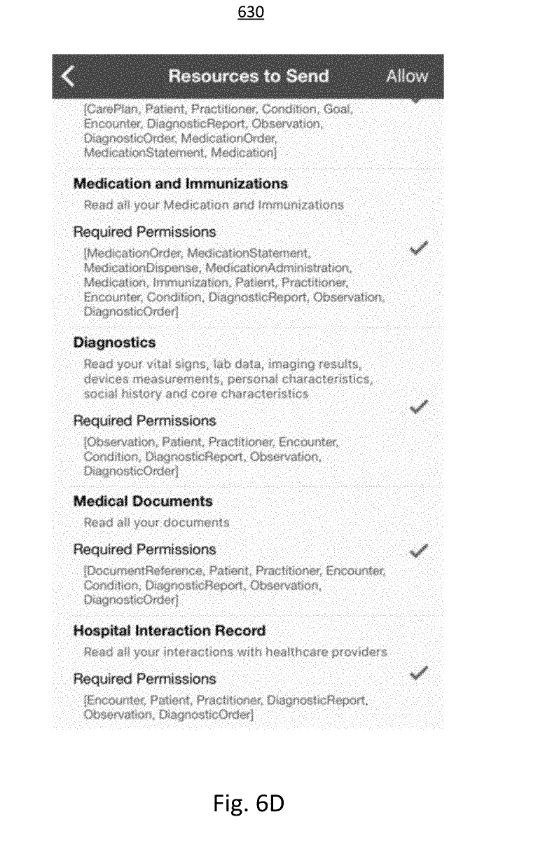

Upon receiving the token, patient computing device 102-A returns consent to validation system 108 using the token at message 210. The consent provides authorization to the medical professional to access data of the patient. In one embodiment, the consent received from the patient may include data access parameters to define a level of access authorized for the medical professional. The data access parameters may include any parameter defining access to the patient data. For example, the data access parameters may define a granular level of access for the medical professional to access the patient data to thereby permit access to, or restrict access from, certain types of patient data (e.g., patient demographics, medicals, diagnoses, etc.). In another example, the data access parameter may define an expiration time period associated with the consent (e.g., a day, a week, a year, no expiration, etc.). The data access parameters may be modified or revoked at any time by the patient. In yet another example, the data access parameters may be defined based on standards in sharing patient data (e.g., government mandated standards). The managing of the data access parameters is further discussed below with respect to FIG. 6.

At message 212, validation system 108 sends the token to token gatekeeper 112. Token gatekeeper 112 comprises a database for storing the token with its data access parameters. Every transaction for accessing the patient data stored in EHR system 108 is approved or denied by token gatekeeper 112 to thereby ensure that the transaction complies with restrictions defined by the data access parameters. Further, token gatekeeper 112 records all transactions for access the patient data, which is viewable by the patient.

The database of token gatekeeper 112 associates the token with the patient. In one embodiment, if a request for a token for the patient (i.e., received as message 206) was previously generated and stored in the database of token gatekeeper 112, instead of validation system 108 generating a new token and returning the new token at message 210, validation system 108 retrieves the previously generated token associated with the patient from token gatekeeper 112 and returns the token to the patient at message 208.

At message 214, validation system 108 returns consent to the medical professional at medical professional computing device 102-B. In one embodiment, the consent may be a notification sent to the communication address associated with the medical professional. The communication address may be based on the communication protocol utilized (e.g., direct address). In one example, the notification is an email with one or more links. The links may direct the medical professional to a registration process (e.g., if the medical professional is accessing the patient data for a first time) or a login portal to access the patient data.

In accordance with the consent, the medical professional at medical professional computing device 102-B retrieves patient data from EHR system 108 at message 220. Each request and retrieval of patient data from EHR system 110 is approved or denied by token gatekeeper 106 based on the data access parameters. Token gatekeeper 106 records each request, which can be reviewed by the patient at any time. Advantageously, message diagram 200 shown in FIG. 2 provides for tokenized communication between devices in a series of requests and replies with a look-back check to token gatekeeper 112 for validating request transactions.

FIG. 3 shows flow diagram of a method 300 for searching for a medical professional, in accordance with one or more embodiments. FIG. 3 will be discussed with reference to FIG. 1. The steps of method 300 may be performed by a search system (not shown in FIG. 1). In one embodiment, the search system may be any system that allows for the search of medical professionals and follows standard API interaction. The search system which may be a discrete system or integrated with another system, such as, e.g., EHR system 110 in FIG. 2.

At step 302, search criteria for a medical professional are received from the patient (e.g., using patient computing device 102-A of FIG. 1). The search criteria may include a name of the medical professional, a specialty of the medical professional, an address of the medical professional, an organization name associated with the medical professional, or any other suitable search criteria. At step 304, a registry is searched for the medical professional using the search criteria to determine a unique identifier associated with the medical professional. In one embodiment, the registry is a registry of medical professionals, each associated with a unique identifier. For example, the registry may be a national provider identifier (NPI) registry comprising NPI numbers each associated with a medical professional. An NPI number is a unique 10 digital number identifying the medical professional.

At step 308, if the medical professional was not found in the registry with its associated unique identifier (at step 306), the patient is notified. The notification may be a message or an indication that the search criterial did not return any results. In one example, the notification may be the message: “bad medical professional information.”

At step 310, if the medical professional was found in the registry with its associated unique identifier (at step 306), confirmation is received from the patient (e.g., using patient computing device 102-A) to confirm that the identified medical professional found in the registry is who the patient was searching for. At step 312, once the identified medical professional is confirmed by the patient, a database is searched using the unique identifier for the medical professional and its associated communication address (e.g., direct address). The database may be any database of medical professionals each being associated with a unique identifier (e.g., NPI number) and one or more communication address. In one embodiment, the database may be a database associated with the search system. In another embodiment, the database may be a database associated with EH R system 110. In yet another embodiment, the database is an Epic address book for medical professionals.

At step 314, if the medical professional was found in the database with its associated communication address (at step 312), the communication address associated with the medical professional is returned to the patient (e.g., at patient computing device 102-A) at step 320. The patient may send an invitation to access the patient data to the medical provider (at message 202 of message diagram 200) using the communication address returned at step 320 by method 300.

At step 316, if the medial professional was found in the database but the communication address associated with the medical professional was not found (at step 312), validation system 108 (i.e., a database associated with validation system 108) is searched. The validation system 108 may be an identity validation system configured to authenticate the identity of a user, such as, e.g., the patient, the medical provider, or any other user. In one embodiment, validation system 108 is a secure messaging platform configured to validate the identity of users and permit secure communication between the validated users, such as, e.g., a DataMotion™ system. Validation system 108 may be searched based on the NPI number associated with the medical professional, the name of the medical professional, the specialty of the medical professional, or any other suitable search criteria.

At step 326, if the communication address associated with the medical professional was found in validation system 108 at step 424, then the records of the database (i.e., the database searched at step 312) are updated with the communication address and the communication address is returned to the patient at step 320. However, if the communication address associated with the medical professional was not found in validation system 108 at step 324, a request is sent to the medical professional (at medical professional computing device 102-B) at step 328 requesting that the medical professional provide his or her communication address. Once the medical professional provides his or her communication address, the records of the database (i.e., the database searched at step 312) are updated with the communication address at step 326 and the communication address is returned to the patient at step 320.

In one embodiment, if the medical professional does not know his or her communication address, the medical professional may be prompted to retrieve or recover his or her communication address or register for a new address (not shown in FIG. 3) from validation system 108. This may involve, for example, the medical professional validating his or her identity with validation system 108. Once recovered, the communication address associated with the medical professional may be used to updated the records of the database (i.e., the database searched at step 312) at step 326 and the communication address is returned to the patient at step 320.

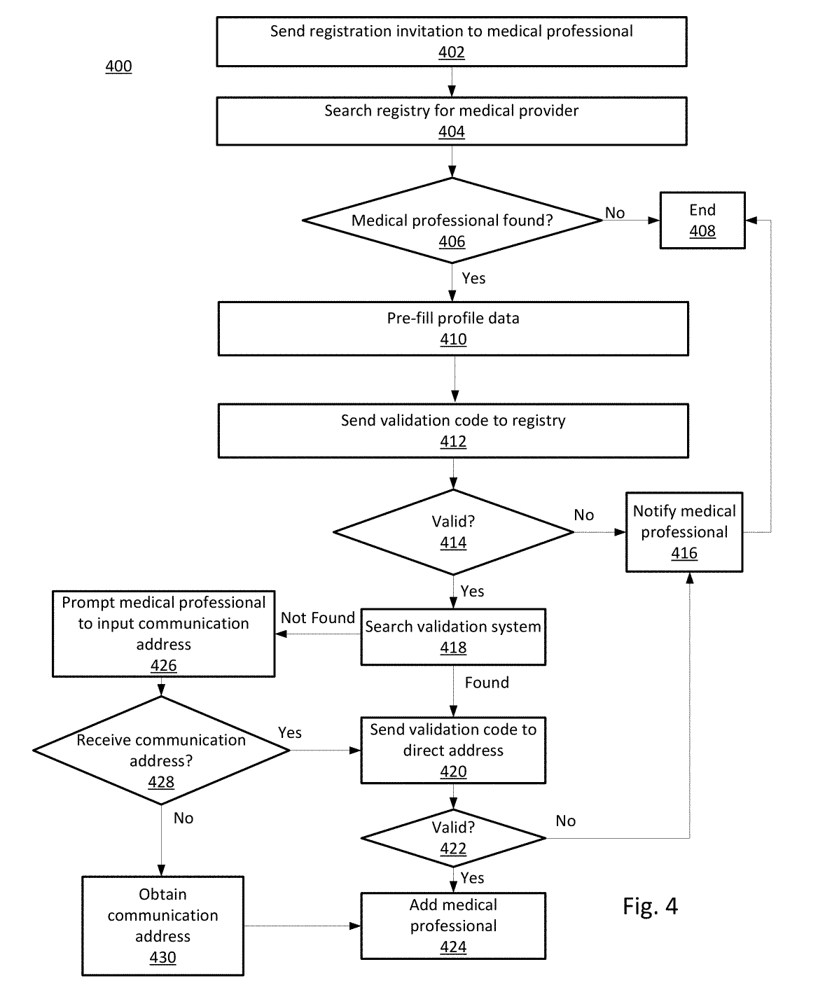

At step 318, if the medical professional was not found in the database (at step 312), the medical professional is prompted to register with the database (i.e., the database searched at step 312). Registration of the medical professional with the database is further discussed below with respect to FIG. 4.

FIG. 4 shows flow diagram of a method 400 for registration of a medical professional with a database (e.g., of a search system), in accordance with one or more embodiments. Method 400 may be performed at step 322 of FIG. 3. The steps of method 400 may be performed by the database by interacting with devices coupled to network 104.

At step 402, an invitation for registration is sent to the medical professional (i.e., at medical professional computing device 102-A). The invitation may be sent by any suitable means (other than via the communication address). In one example, the invitation may include a message with a link directing him to a registration portal. In response, the medical professional inputs his or her personal information, such as, e.g., name, specialty, NPI number, etc.

At step 404, the registry (e.g., the NPI registry searched in step 304 of FIG. 3) is searched for the medical professional. The search may be based on the personal information received from the medical professional. At step 406, if the medical professional was not found in the registry, the process ends at step 408.

If the medical professional was found in the registry, the profile of the medical professional is pre-filled at step 410 using data from the registry. The pre-filled information may also include the personal information received from the medical provider or any other suitable data of the medical professional. For example, the pre-filled information may include a name of the medical professional, a specialty of the medical professional, an NPI number associated with the medical professional, etc. In one embodiment, the pre-filled information is reviewed and confirmed by the medical professional.

At step 412, a validation code is sent to the registry (e.g., the NPI registry) in order to validate that the medical professional is the medical professional associated with the data retrieved from the registry. The medical professional enters the validation code and, at step 414, if the validation code entered by medical professional is not valid (e.g., the validation code from the medical professional does not match the validation code received by the registry), the medical professional is notified at step 416 and the process ends at step 408.

If the validation code entered by the medical professional is valid (e.g., the validation code from the medical professional matches the validation code received by the registry), at step 418, validation system 108 is searched to determine the communication address (e.g., direct address) associated with the medical professional. If the communication address associated with the medical professional is found in validation system 108, a validation code is sent using the communication address associated with the medical provider. The validation code may be the same or different from the validation code sent to the registry at step 412. The validation code sent via the direct address is validated against the validation code stored in validation system 108. If the validation code is valid at step 422, the medical professional is added to the database (e.g., of the search system) at step 424 to register the medical professional. If the validation code is not valid at step 422, the medical professional is notified at step 416 and the process ends at step 408.

At step 426, if the medical professional is not found in validation system 108, the medical professional is prompted to manually input the communication address at step 426 (i.e., using medical professional computing device 102-B). If the communication address is received from the medical professional at step 428, the process proceeds to step 420 and a validation code is sent to the medical professional via the communication address. If a communication address was not received from the medical professional at step 428, the medical professional may be prompted to obtain a communication address at step 430. For example, the communication address may not have been received from the medical professional because the medical professional does not own a communication address, because the medical professional does not remember his or her communication address, or for any other reason. In one embodiment, the communication address is obtained by retrieving or recovering the communication address or registering for a new address from validation system 108. This may involve, for example, the medical professional validating his or her identity with validation system 108. Once recovered, the communication address associated with the medical professional may be added to the database (e.g., of the search system) to register the medical professional.

FIG. 5 shows a block diagram of an exemplary system architecture 500 for generating a unique digital identifying token for the patient, in accordance with one embodiment. The token may be generated in response to a request for a token at message 206 in message diagram 200 in FIG. 2.

A registration 502 is performed to register the patient using patient computing device 102-A with validation system 108 via, e.g., communications system 100 of FIG. 1. For example, the patient may utilize an app executing on patient computing device 102-A (e.g., a mobile device) for registering with validation system 108 via network 104. The identity of the patient is validated by validation system 108 by comparing received validation information received from the patient with stored validation information of the patient stored in validation system 108. The stored information may be received by validation system 108 during a prior registration procedure with the patient. The validation information (i.e., received and stored validation information) may include any information that can authenticate the identity of the patient. For example, the validation information may include a username and password, a personal identification number (PIN), one or more security questions and answers, biometric authentication (based on, e.g., fingerprints, palm patterns, facial images, iris or retinal scans, voice, etc.), and/or any other suitable validation information.

Upon validating the identity of the patient, validation system 108 issues a unique digital identification token 504. Token 504 may be utilized (e.g., in messages sent in message diagram 200 of FIG. 2) to identify the patient for the secure exchange of information. Token 504 may be any token that can authenticate the identity of the patient. In one embodiment, token 504 is an authentication key.

FIG. 6A illustratively shows a block diagram of a user interface 600 for managing access to patient data, in accordance with one or more embodiments. In one embodiment, user interface 600 is a graphical user interface of an app executing on patient computing device 102-A. A patient may interact with user interface 600 for configuring data access parameters stored on token gateway 112.

User interface 600 presents one or more health information resources 602-A, 602-B, . . . , 602-N (collectively referred to as health information resources 602). One or more health information resources 602 may be selected by a patient to define a granular level of access for a medical professional accessing the patient data. Health information resources 602 may represent categories or subsets of the patient data. For example, health information resources 602 may represent one or more of patient demographics, family history, allergy and intolerance, medicine, diagnoses, and operation/therapy history.

User interface 600 allows the patient to configure data access parameters to provide access to part or all of their patient data to the medical professional at a fine level of granularity. The patient may track and audit access to their data at all times and may revoke consent to end that medical professional's participation at any time. In particular, at any time, the patient can review who/what has access to the patient data, can grant or revoke access to the medical professional, and can grant or revoke access to a define subset of the patient data.

In one embodiment, the patient data is structured patient data and the health information resources 602 are defined based on the structure of the patient data. For example, the patient data may be structured in XML format, FHIR (fast healthcare interoperability resources) format, HL7 (Health Level Seven) formation, or any other structured format. Health information resources 602 may be defined according to the structure of the patient data to thereby define granular access to the patient data. For example, the structured patient data may be structured according to levels (or categories) or sub-levels defining fields, such as, e.g., patient demographics, family history, allergy and intolerance, medicine, diagnoses, operation/therapy history, etc. The patient may select health information resources 602 corresponding to levels or sub-levels of the patient data via user interface 600 to permit (or deny) access to those levels or sub-levels. For example, the patient may select such fields as patient demographics, family history, allergy and intolerance, medicine, diagnoses, operation/therapy history, etc.

In one embodiment, where the patient data is not structured, such as, e.g., where the patient data is formatted as paragraphs of information, relevant data may be extracted from the unstructured data and structured. In one embodiment, the unstructured data is structured using methods known in the art.

In one embodiment, the patient may interact with health information resources 602 via user interface 600 to attach a lifespan or expiration to each grant or consent of access to the patient data or a particular portion of the patient data. For example, the patient may interact with health information resources 602 by selecting one of a plurality of predefined expiration times or by inputting an expiration time. In some embodiments, a predefined expiration time is set by default and can be overridden by the patient. Each request by a medical professional for patient data is checked against the expiration by token gatekeeper 112 prior to granting access to that patient data.

FIGS. 6B, 6C, and 6D show exemplary user interfaces 610, 620, and 630, respectively, for managing access to patient data, in accordance with one embodiment. User interface 610 shows health information resources for patient demographics, allergy and intolerance, diagnoses, family member history, operation/therapy history, and care provision. User interface 620 shows health information resources for care provision, medication and immunizations, diagnostics, medical documents, and hospital interaction records. User interface 630 shows health information resources for medication and immunizations, diagnostics, medical documents, and hospital interaction records. A patient may interact with user interface 610, 620, and 630 for selecting one or more health information resources to permit (or deny) access for a medical professional. Health information resources may include sub-levels of data (shown in FIGS. 6B, 6C, and 6D under the Required Permissions label), each of which may be selected by the patient to permit (or deny) access with a finer level of granularity.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 3 and 4, and one or more of the message flows described herein, including one or more of the messages of FIG. 2. Certain steps of the methods described herein, including one or more of the steps of FIGS. 3 and 4, and certain messages of the message flow described herein, including one or more messages of FIG. 2, may be performed by a server or by another processor in a network-based cloud-computing system. Certain steps of the methods described herein, including one or more of the steps of FIGS. 3 and 4, and certain messages of the message flow described herein, including one or more messages of FIG. 2, may be performed by a client computer in a network-based cloud computing system. The steps of the methods described herein, including one or more of the steps of FIGS. 3 and 4, and certain messages of the message flow described herein, including one or more messages of FIG. 2, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 3 and 4, and certain messages of the message flow described herein, including one or more messages of FIG. 2, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

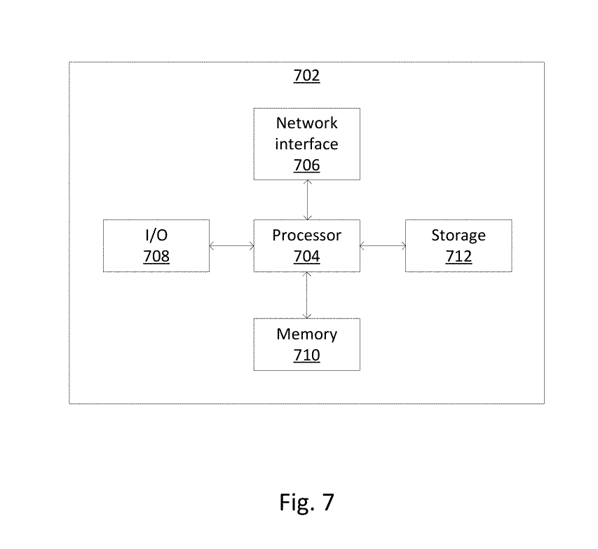

A high-level block diagram 700 of an example computer that may be used to implement systems, apparatus, and methods described herein is depicted in FIG. 7. Computer 702 includes a processor 704 operatively coupled to a data storage device 712 and a memory 710. Processor 704 controls the overall operation of computer 702 by executing computer program instructions that define such operations. The computer program instructions may be stored in data storage device 712, or other computer readable medium, and loaded into memory 710 when execution of the computer program instructions is desired. Thus, the method steps of FIGS. 3 and 4 and the messages of FIG. 2 can be defined by the computer program instructions stored in memory 710 and/or data storage device 712 and controlled by processor 704 executing the computer program instructions. For example, the computer program instructions can be implemented as computer executable code programmed by one skilled in the art to perform the method steps of FIGS. 3 and 4 and messages of FIG. 2. Accordingly, by executing the computer program instructions, the processor 704 executes the method steps of FIGS. 3 and 4 and the messages of FIG. 2. Computer 702 may also include one or more network interfaces 706 for communicating with other devices via a network. Computer 702 may also include one or more input/output devices 708 that enable user interaction with computer 702 (e.g., display, keyboard, mouse, speakers, buttons, etc.).

Processor 704 may include both general and special purpose microprocessors, and may be the sole processor or one of multiple processors of computer 702. Processor 704 may include one or more central processing units (CPUs), for example. Processor 704, data storage device 712, and/or memory 710 may include, be supplemented by, or incorporated in, one or more application-specific integrated circuits (ASICs) and/or one or more field programmable gate arrays (FPGAs).

Data storage device 712 and memory 710 each include a tangible non-transitory computer readable storage medium. Data storage device 712, and memory 710, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 708 may include peripherals, such as a printer, scanner, display screen, etc. For example, input/output devices 708 may include a display device such as a cathode ray tube (CRT) or liquid crystal display (LCD) monitor for displaying information to the user, a keyboard, and a pointing device such as a mouse or a trackball by which the user can provide input to computer 702.

Any or all of the systems and apparatus discussed herein, including computing devices 102, token gatekeeper 106, validation system 108, and EHR system 110 of FIG. 1 may be implemented using one or more computers such as computer 702.

One skilled in the art will recognize that an implementation of an actual computer or computer system may have other structures and may contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the described invention and that various modifications may be implemented by those skilled in the art without departing from the scope and spirit of the invention. Those skilled in the art could implement various other feature combinations without departing from the scope and spirit of the invention.

1. A method for accessing patient data, comprising:
in response to a request for consent for a medical professional to access patient data of a patient, receiving, at a system comprising a processor, a request from the patient for a token validating an identity of the patient;
transmitting, at the system, the token to the patient;
receiving, at the system, the consent with data access attributes from the patient using the token, the data access attributes comprising an expiration time associated with the consent and a granular level of access defining one or more subsets of the patient data the medical professional is authorized to access; and
transmitting, at the system, a notification to a communication address associated with the medical professional, the notification indicating that the medical professional is authorized to access the patient data in accordance with the data access attributes.

2. The method of claim 1, further comprising:
transmitting the token with the data access attributes to a token gatekeeper, wherein the token gatekeeper stores an association between the patient and the token and between the patient and the data access attributes.

3. The method of claim 2, wherein each transaction for the medical professional to access the patient data is authorized by the token gatekeeper based on the data access attributes.

4. The method of claim 3, wherein each transaction for the medical professional to access the patient data is recorded by the token gatekeeper.

5. The method of claim 1, further comprising:
in response to the request from the patient for the token, generating the token by validating the identity of the patient.

6. The method of claim 1, further comprising:
in response to the request from the patient for the token, retrieving a previously generated token associated with the patient from a token gatekeeper as the token.

7. The method of claim 1, wherein the one or more subsets of patient data are defined based on a structure of the patient data.

8. The method of claim 7, wherein the structure of the patient data defines subsets of data as being associated with one or more of patient demographics, allergies, diagnoses, family member history, and operation or therapy history.

9. The method of claim 1, wherein the request for consent for the medical professional to access the patient data is in response to an invitation sent to the medical professional to access the patient data.

10. The method of claim 9, wherein the invitation is sent by the patient searching for the communication address associated with the medical professional.

11. The method of claim 10, wherein if the medical professional is not found during the searching, registering the medical professional.

12. The method of claim 1, wherein the communication address associated with the medical professional is authenticated to be associated with the medical professional.

13. A non-transitory computer readable medium storing computer program instructions, which, when executed on a processor, cause the processor to perform operations comprising:
in response to a request for consent for a medical professional to access patient data of a patient, receiving a request from the patient for a token validating an identity of the patient;
transmitting the token to the patient;
receiving the consent with data access attributes from the patient using the token, the data access attributes comprising an expiration time associated with the consent and a granular level of access defining one or more subsets of the patient data the medical professional is authorized to access; and
transmitting a notification to a communication address associated with the medical professional, the notification indicating that the medical professional is authorized to access the patient data in accordance with the data access attributes.

14. The non-transitory computer readable medium of claim 13, the operations further comprising:
transmitting the token with the data access attributes to a token gatekeeper, wherein the token gatekeeper stores an association between the patient and the token and between the patient and the data access attributes.

15. The non-transitory computer readable medium of claim 14, wherein each transaction for the medical professional to access the patient data is authorized by the token gatekeeper based on the data access attributes.

16. The non-transitory computer readable medium of claim 15, wherein each transaction for the medical professional to access the patient data is recorded by the token gatekeeper.

17. An apparatus for accessing patient data, comprising:
a processor; and
a memory to store computer program instructions, the computer program instructions when executed on the processor cause the processor to perform operations comprising:
in response to a request for consent for a medical professional to access patient data of a patient, receiving a request from the patient for a token validating an identity of the patient;
transmitting the token to the patient;
receiving the consent with data access attributes from the patient using the token, the data access attributes comprising an expiration time associated with the consent and a granular level of access defining one or more subsets of the patient data the medical professional is authorized to access; and
transmitting a notification to a communication address associated with the medical professional, the notification indicating that the medical professional is authorized to access the patient data in accordance with the data access attributes.

18. The apparatus of claim 17, the operations further comprising:
in response to the request from the patient for the token, generating the token by validating the identity of the patient.

19. The apparatus of claim 17, wherein the one or more subsets of patient data are defined based on a structure of the patient data.

20. The apparatus of claim 17, wherein the request for consent for the medical professional to access the patient data is in response to an invitation sent to the medical professional to access the patient data.
